(19) United States
(12) Patent Application Publication
(10) Pub. No.: US 2008/0316576 A1
(43) Pub. Date: Dec. 25, 2008

(54) Method and Device for Polarization Conversion Using Quantum Dots

(75) Inventors: Laurens W. Molenkamp, Wurzburg (DE); Georgy Astakhov, Wurzburg (DE); Wolfgang Ossau, Uettingen (DE); Tobias Kressling, Wurzburg (DE); Alexei Platonov, St. Petersburg (RU)

Correspondence Address: BROWDY AND NEIMARK, P.L.L.C.;624 NINTH STREET, NW, SUITE 300, WASHINGTON, DC, 20001-5303, US

(73) Assignee: ETECH AG, SCHLIEREN (CH)

(21) Appl. No.: 11/997,758

(22) PCT Filed: Aug. 4, 2006
(86) PCT No.: PCT/CH2006/000407

§ 371 Date: Jul. 28, 2008

Related U.S. Application Data
(60) Provisional application No. 60/705,189, filed on Aug. 4, 2005.

(51) Int. Cl. G02F 1/01; G02B 27/28; G02F 3/02

(52) U.S. Cl. 359/290; 359/484; 359/108; 977/774; 977/834; 977/933

(57) ABSTRACT

A novel and efficient method for polarization conversion, particularly from linear polarization to circular polarization, and, importantly, vice versa, is obtained using shapeanisotropic self-assembled quantum dots, which, having the advantage of extremely small size (nanometer scale), may be readily incorporated into photonic crystals and/or other optical components. Such devices also have the advantage of working in the absence of an applied magnetic field. Such devices also, when a voltage bias is applied, can be used to manipulate electron spin by manipulating light polarization in the same circuit, and vice versa. This permits a high degree of control for either or both of these in spintronics and/or optical devices, the biased quantum dot being used as a nanometer scale electro-optic modulator. Components utilizing the method and/or devices may be used as part of highly compact optical computing networks and/or spintronics systems for e.g., information processing, quantum computation, holography, and data recording.

### TECHNICAL FIELD OF THE INVENTION

The invention relates to a method and a device for polarization conversion.

### SUMMARY OF THE INVENTION

A novel and efficient method for polarization conversion, particularly from linear polarization to circular polarization, and, importantly, vice versa, is obtained using shapeanisotropic self-assembled quantum dots, which, having the advantage of extremely small size (nanometer scale), may be readily incorporated into photonic crystals and/or other optical components. These quantum dots and consequently the components incorporating them also have the advantage of extremely small size (tens of nanometers scale). These components may be used as part of highly compact optical computing networks and/or spintronics systems for e.g., information processing, quantum computation, holography, and data recording.

Such devices also have the advantage of working in the absence of an applied magnetic field. Such devices also, when a voltage bias is applied, can be used to manipulate electron spin by manipulating light polarization in the same circuit, and vice versa. This permits a high degree of control for either or both of these in spintronics and/or optical devices, the biased quantum dot being used as a nanometer scale electro-optic modulator.

The conversion originates from the quantum beats of linearly and circularly polarized photon states induced by the anisotropic shape of semiconductor quantum dots, which are deliberately constructed with an elongated form and hence a low symmetry to provide anisotropic exchange splitting. This anisotropic exchange splitting manifests as inbuilt linear polarization under non-resonant excitations, and as circular-to-linear polarization conversion under quasi-resonant excitations. It is an important feature of this invention that counter-conversion, i.e., linear-to-circular polarization conversion, can also be achieved under quasi-resonant conditions. It is also an important feature that the polarization conversion effects occur in the absence of an applied magnetic field.

Furthermore the anisotropic exchange splitting depends on the number (even or odd) of electrons present in the quantum dot which can be controlled. It is possible to manipulate electron spin by manipulating light polarization in the same circuit, and vice versa. A voltage bias is used to control and/or select the polarization state of a photon, and thus the spin state of the photon-induced electron: alternatively, the voltage bias is used to control the total spin of electrons, and thus the polarization state of the electron-induced photon. This permits a high degree of control for either or both of these in spintronics and/or optical devices, the biased quantum dot having application as a nanometer scale electro-optic modulator, which is able to support coherent operations on the polarization of the photons, and so be used e.g., for information processing.

### SHORT DESCRIPTION OF THE DRAWINGS

FIG. 1 shows CdSe/ZnSe quantum dots. a, Atomic force microscope image of a CdSe/ZnSe quantum dot layer. The QDs are elongated along [110] axis. b, PL spectra for nonresonant (dotted curve) and resonant (solid curve) excitation, respectively. The phonon replica is well resolved in the PL spectrum as a narrow peak, separated from the laser line by the LO-phonon energy, which equals 32 meV in ZnSe.

FIG. 2 shows polarization conversion by CdSe/ZnSe QDs. a, Angle scan of the linear polarization detected at the PL maximum under nonresonant σ⁺ (open symbols) and σ⁻ (solid symbols) circularly polarized excitation. The solid curves are fits assuming ρ_{l,l′}=ρ₀ cos(2α). The Inset shows the same data (but shifted by a constant of ρ₀ to positive values) in polar coordinates. b, Angle scan of linear polarization detected at the phonon replica under σ⁺ (open symbols) and σ⁻ (solid symbols) circularly polarized resonant excitation. The solid curves are fits assuming ρ_{l,l′}=ρ₀ cos (2α∓φ₀). The Inset shows the same data in polar coordinates. (Again, the data were shifted to positive values to enable the polar plot) c, Angle scan of the degree of circular polarization detected at the phonon replica under linearly polarized resonant excitation. The curve is again a fit, assuming ρ_{c}=ρ₀ sin(2α). The Inset shows absolute value of the same data (|ρ_{c}|=|ρ₀ sin(2α)|) in polar coordinates. Zero rotation angle in all panels means that the linear analyzer (polarizer) is orientated parallel to the [110] crystallographic direction. The magnetic field for all data is zero.

FIG. 3 shows schematics of a voltage-controlled QD converter. Two QD layers with opposite sign of anisotropic exchange splitting [symbol] ₗ=− [symbol] ᵣ constitute the active area of the device. Electrons are provided by the ohmic contacts. a, At positive bias electrons are collected in the left layer and as a result, Ωₗ=0. [010]-linearly polarized light is converted by the right QD layer (Ωᵣ>0) to σ⁺ circularly polarized light. b, At negative bias the process is reversed, i.e. Ωᵣ=0 and Ωₗ<0, so that [010]-linearly polarized light is now converted to σ⁻ circularly polarized light. In low part of each panel the conduction band (E_{C}) profiles for the given bias direction are sketched.

### DETAILED DESCRIPTION OF PREFERRED EMBODIMENTS

### Quantum Dot Polarization Conversion Through Entanglement of Linearly and Circularly Polarized Photons

The standard device for optical polarization conversion is the quarter-wave plate, where incoming linearly polarized light is transformed into circularly polarized light at the exit. An assortment of such and similar devices is present in any setup for optical information processing. Also for quantum computation, holography and optical recording, polarization converters are of utmost importance. The general tendency towards miniaturization and high-density integration of opto-electronic circuits has stimulated much effort in this field. All-optical nanostructure integrated circuits based on photonic crystals [1] have been proposed [2] and demonstrated [3]. Such miniaturized systems require novel approaches for the realization of polarization conversion devices which, in order to achieve optimum integration, must be of nanometer size and readily built-in into the optical system. Here we report on efficient conversion of optical polarization using self assembled quantum dots (QDs), which are a few tens of nanometer in size and can be easily integrated in photonic crystals [4, 5]. The conversion occurs due to the entanglement of linearly and circularly polarized states resulting from the natural anisotropic shape of the semiconductor QDs [6, 7, 8]. Moreover, the anisotropic exchange splitting depends on the number of electrons in a QD [9], and we propose a scheme where the biased QD acts as a nm-scale electro-optic modulator, allowing coherent operations on the polarization of the photons.

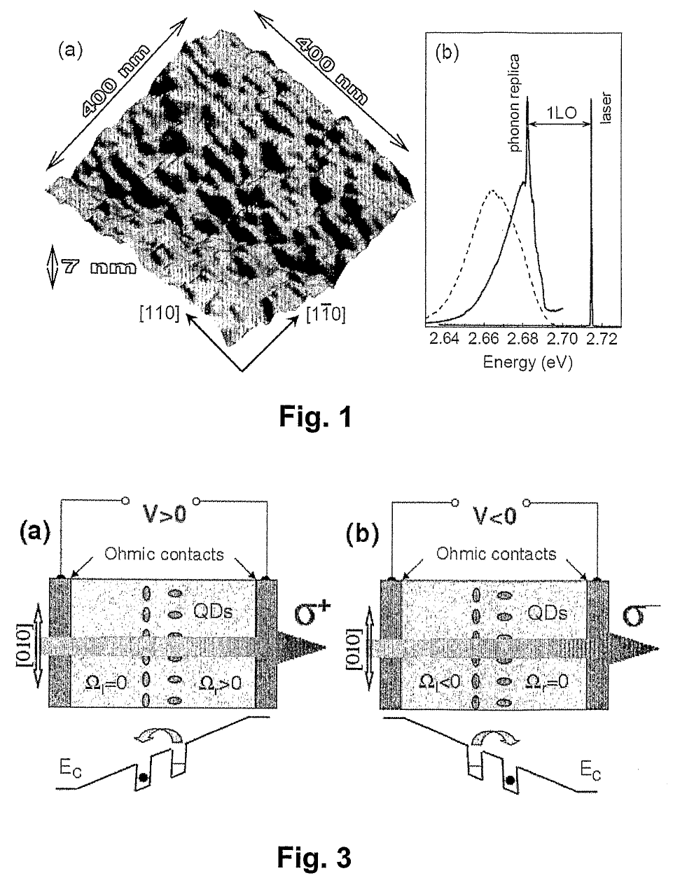

Quantum dots (QDs) are essentially zero-dimensional semiconductors resulting in a line spectrum in the optical frequency range, and are therefore referred to as man-made atoms. As can clearly be seen from the AFM image (FIG. 1a) the self-assembled CdSe/ZnSe QDs that we use in this study (for fabrication details see the Methods section) tend to be elongated along a particular crystallographic axis. The symmetry of the dot ensemble is reduced to C₂ᵥ, as compared with the full T_{d} symmetry of the zinc blende bulk lattice. This implies that such dots exhibit an extreme spatial anisotropy.

The interaction between light and a QD dot results in the formation of excitons, where the polarization of the light is linked to the spin states of the exciton. The exciton itself consists of an electron and a hole bound by the Coulomb potential. The confinement of the exciton in the small volume of the QD leads to an enhancement of the electron-hole exchange interaction. Due to the low symmetry of our QDs this results in an anisotropic exchange splitting [10], [symbol] . Typically, for CdSe/ZnSe QDs, [symbol] ˜0.1 meV. This splitting is directly observed in the photoluminescence (PL) spectrum of a single QD through the formation of line doublets [7, 9]. When an ensemble of QDs is probed, the exchange splitting [symbol] is buried in the much larger (˜30 meV) inhomogeneous broadening of the PL band (FIG. 1b). However, for non-resonant excitation, in thermal equilibrium, the anisotropic exchange splitting manifests itself as an inbuilt linear polarization. FIG. 2a shows the degree of linear polarization measured in a fixed coordinate basis while the sample is rotated by an angle α. The polarization oscillates as cos(2α), just as would be observed for a linear polarizer. As can clearly be seen from the polar plot in the inset of FIG. 2a, the polarization axis is linked to the [110] crystallographic direction, and it does not depend on (the handedness of) the polarization of the exciting light. This behavior is what one intuitively expects from the shape of the QDs found in FIG. 1a.

Rather more counter-intuitive results are obtained under quasi-resonant excitation. The PL spectrum of the QDs is now dominated by a narrow peak that we attribute as a phonon replica of the laser line (FIG. 1b). It appears due to fast excitonic recombination in combination with the emission of an LO-phonon. Under these conditions the polarization axis is no longer fixed to the [110] crystalline direction. As shown in FIG. 2b, the angle dependence of the linear polarization now behaves as cos(2α±φ₀), where the plus (minus) sign depends on the handedness of the circularly polarized excitation light. This behavior is ever so more clearly apparent from the polar plot in the inset of FIG. 2b. The polarization axis is rotated away from [110] by an angle φ₀≈40°, clockwise towards the [100] direction for σ⁺, and counter-clockwise towards the [010] direction for σ⁻ polarization of the incoming light. Such a behavior implies, indeed, circular-to-linear polarization conversion.

In order to estimate conversion efficiency under ca circular-polarized excitation, denoted with P_{c}=±1, we describe the total polarization of the emitted light by a vector [ρ_{l′},ρₗ,ρ_{c}] inside the Poincaré sphere. Here, ρ_{l′} is the linear polarization along [110], ρₗ is the linear polarization along [100], and ρ_{c} is the circular polarization. These Stokes coordinates satisfy \sqrt{ρ_{l′}²+ρₗ²+ρ_{c}²}≦1. Under efficient conversion we understand the condition |ρₗ|>|ρ_{l′}| and |ρₗ|>|ρ_{c}|. According to FIG. 2b the maximum amplitude of the linear polarization is ρ₀=2.7%, so we have (see also the Methods section) ρₗ=ρ₀ sin(2φ₀)≈2.6% and ρ_{l′}=ρ₀ cos(2φ₀)≈0.4%. We also have measured the optical orientation [11], i.e. the degree of circular polarization of the emitted light under circularly polarized excitation and obtained ρ_{c}≈1%. For the experimental values the above condition is obviously fulfilled.

We should note that the QD converter demonstrated here is far from ideal. For a high quality quarter-wave plate one typically has ρₗ>99%. This imperfection is compensated by the small size of the QDs, only a few tens of nanometers, i.e., much smaller than the operating wavelength (460 nm). Furthermore, the dots can easily be integrated in semiconductor circuits. An important advantage of the QD converter is the possibility of control by applying a bias voltage, as discussed below. Moreover, one can show theoretically that for optimized QD dimensions a value ρₗ≈50% can be achieved.

Polarization conversion in low dimensional systems has been predicted by Ivchenko et. al. [12] In the presence of a preferential direction for the excitonic states in QDs, the circularly and linearly polarized contributions to the emission are entangled. Obviously, an external magnetic field can induce this preferential direction. Meanwhile, magnetic field-induced polarization conversion has been demonstrated experimentally in superlattices [13]. However, involving the anisotropic exchange interaction to define the preferential direction induces entanglement of the circular and the [100] linear polarizations even in zero magnetic field. Ivchenko et al-'s predictions [12] were furthermore partly confirmed in quantum beat experiments [14] where precession of the linear polarization component (excited with linearly polarized light) around the preferential direction at Larmor frequency Ω was observed. Within the pseudospin formalism [13], the time evolution after circularly polarized excitation P_{c} at t=0 can be expressed as ρ_{c}(t)=P_{c} cos(Ωt)exp(−t/τₛ) and ρₗ(t)=P_{c} sin(Ωt)exp(−t/τₛ). The circular and linear polarizations thus oscillate in antiphase, decaying with pseudospin relaxation time τₛ to zero. In QDs, the spin relaxation time of a single hole was found to be about 10 ns [15], the spin relaxation time of a single electron is even longer, in a millisecond range [16]. Therefore, τₛ for an exciton is sufficiently long to have τₛ>>tᵣ, where tᵣ˜100 ps [17] is the radiative recombination time. In steady-state, i.e. under continuous wave (cw) excitation, the degree of polarization is obtained after averaging the polarization evolution with the distribution tᵣ⁻¹ exp(−t/tᵣ) of the emission probability [11], yielding

$${ρ}_{l} = \frac{Ω T}{1 + {( Ω T )}^{2}} {P}_{c} and {ρ}_{c} = \frac{1}{1 + {( Ω T )}^{2}} {P}_{c} . \qquad ( 1 )$$

Here, T⁻¹=tᵣ⁻¹+τₛ⁻¹ and we assume that T/tᵣ≈1 (slow spin relaxation). We note that the QD ensemble is inhomogeneous, i.e., the anisotropic exchange splitting fluctuates from dot to dot. This can be taken into account by using average values | [symbol] Ω [symbol] |≠\sqrt{ [symbol]Ω² [symbol]} in Eqs. (1).

Eqs. (1) are simple but essential for the QD conversion mechanism. The second identity in Eqs. (1) is very similar to the Hanle effect, with the Zeeman splitting induced by a magnetic field replaced by the zero-field anisotropic exchange splitting. In quantum dots the anisotropic exchange splitting [symbol] is an order of magnitude larger than in superlattices. As a result the polarization conversion under cw excitation is significant. The conversation factor is K=ρₗ/ρ_{c}= [symbol] Ω [symbol] T. In QDs ΩT is typically in the range of ΩT˜1-100, which is in good agreement with the present experimental data, as we found K≈3. It also follows from equations (1) that for ΩT=1 the polarization can reach ρₗ=ρ_{c}=50%.

The most intriguing effect is counter-conversion, i.e., conversion from linear to circular polarization, which should occur due to time reversal symmetry. Indeed we observed this effect, as shown in FIG. 2c. Upon linear polarized excitation along [010], σ⁺ polarized emission appears. The effect changes sign to σ⁻ when excitation occurs along [100]. No conversion is observed when the linear polarizer at the excitation was oriented along [110] or perpendicular directions. This behavior is in a good qualitative agreement with theory, and obeys similar equations as Eqs. (1) upon interchange of the indices l [symbol] c and reversing the sign of Ω.

The anisotropic exchange splitting is modified drastically in a negatively charged QD, containing a single extra electron. With a photo-created electron the extra electron forms the energetically favorable singlet state with zero total electron spin. Since the electron-hole exchange interaction is proportional to the spins [10] of electrons and holes, the anisotropic exchange splitting in a charged QD equals [9] exactly zero ( [symbol] =0). By applying a bias voltage, additional electrons can be pushed into or out of the QDs. This gives extra functionality to the QD converter, and may provide a flexible approach for spin-based devices. Due to the optical selection rules [11], the spin of a photo-excited electron in the conduction band is proportional to the photon's circular polarization. Thus, instead of directly manipulating electron spin one can alternatively control the light polarization within the same circuit.

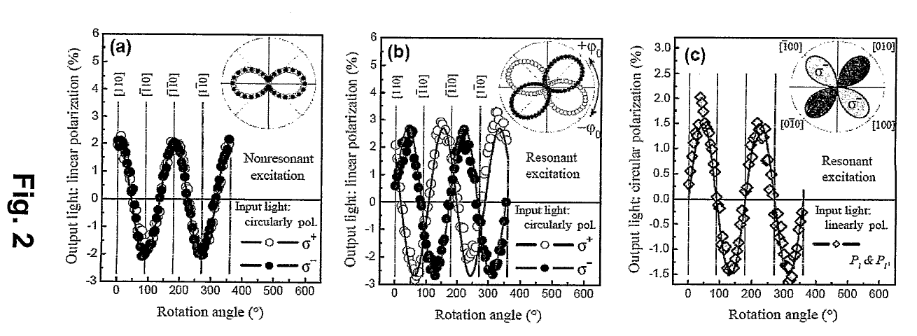

A possible layout of such a device is presented in FIG. 3. The essential part is a double QD layer with anisotropic exchange splittings of opposite signs. (The actual fabrication of such structures will evidently demand further technological effort.) Physically this means that QDs are elongated along the [110] direction in the right layer resulting in a positive Ωᵣ>0, while in the QDs the left layer are elongated in perpendicular direction, corresponding to a negative Ωₗ<0. In general, as can also be seen from Eqs. (1), the conversion depends on the sign of Ω and no conversion occurs for Ω=0.

At positive bias, electrons, provided through the ohmic contacts, are mostly trapped at QDs in the left layer, resulting in zero anisotropic exchange splitting Ωₗ=0 (see FIG. 3a). The right QD layer with Ωᵣ>0 converts linear polarized light along [010], which we denote by Pₗ=−1, into σ⁺ circularly polarized light (ρ_{c}>0). When negative bias is applied, the electrons are transferred into the right QD layer, turning off the conversion there (Ωᵣ=0, see FIG. 3b), and only the left QD layer, where now Ωₗ<0, is optically active. Thus, the conversion changes sign. Such an electrical control of circular polarization (in absence of any magnetic field) is of course already known as electro-optic modulator. However, the electrooptic crystals used in such devices are bulky. The QD converter is a nm-scale device, and it could play a similar role in optical computing as the Datta-Das spin transistor [18] in spin-electronics.

In summary, we have demonstrated efficient circular-to-linear and linear-to-circular light polarization conversion by quantum dots. The conversion occurs in zero magnetic field and is induced by anisotropic exchange splitting. A biased implementation of such QD converters could yield a nm-scale electro-optic modulator. Our findings may have obvious practical applications in information processing.

### Methods

The CdSe/ZnSe QDs used in our experiments are grown by conventional molecular beam epitaxy. One monolayer (0.3 nm) of CdSe is deposited [19] atop a 50 nm-thick ZnSe buffer layer. A growth interrupt of 10 seconds prior to capping by 25 nm ZnSe results in the formation of CdSe QDs by self assembly. Typically, these dots are 1 nm high and sub-10 nm in lateral dimensions. In order to image the QDs using atomic force microscopy (AFM), also an uncapped sample has been grown. The AFM image of this sample, shown in FIG. 1a, shows distinct islands with clearly discernible shape anisotropy. The dots are preferentially elongated along the [110] direction, according to optical characterization.

For optical excitation we use a stilbene-3 dye-laser, pumped by the ultra-violet lines of an Ar-ion laser. In this setup the excitation energy can be varied and carefully tuned to CdSe QD resonant conditions. The polarization is detected at the phonon replica, spectrally separating the excitation and emission. For nonresonant excitation the laser energy is tuned to 2.83 eV, exceeding the band gap of the ZnSe barrier. The sample is mounted on a rotating holder. It's orientation is controlled using a step motor to an accuracy better than 1°. The angle scans of the polarization are carried out using fixed analyzers (high quality Glan-Thompson prisms). In order to detect the polarization degree to an accuracy of ±0.1% we use a conventional optical setup consisting of a photo-elastic modulator operating at frequency f=50 kHz and a two-channel photon counter. The circular polarization ρ_{c} is detected at f and the linear polarizations ρ_{l′}, ρₗ are detected at the double frequency 2f. The linear polarizations ρₗ′ and ρₗ are defined as ρ_{l′}=(I₁₁₀−I_{1 1̅0})/(I₁₁₀+I_{1 1̅0}) and ρₗ=(I₁₀₀−I₀₁₀)/(I₁₀₀+I₀₁₀), respectively. Here I_{xyz} is the intensity of the light polarized along the [xyz] axis of the crystal. When the sample is rotated over an angle α, both components transform as ρ_{l′} cos(2α)−ρₗ sin(2α), with amplitude is ρ₀=\sqrt{ρ_{l′}²+ρₗ²}. For noise reduction all optical experiments were performed at a temperature of 1.6 K. No magnetic fields were applied.

### Some Application Examples

The method for polarization conversion described above may be used in a wide manner of electronic devices with significant advantages over extant products. Some of these applications, depending on the ease of room temperature operation, and price, may well be able to address substantial, high volume applications. Some examples of classes of application include:
The technology could operate in exactly the same way as an liquid crystal display (LCD) and replicate any current application (in displays, and other optical elements such as scanners, shutters, sensors and switches) but have the advantage of being much faster—and hence create new applications as well;
The technology could act as a very high speed optical switching element, for use in optical communications networks. It could be used in, e.g., switches, attenuators, isolators and modulators, which would greatly increase the capacity and speed of (existing and new) fibre links.
The technology could be used to enable ultra high speed Boolean based logic (as against quantum computing) as any logical equation could be implemented.
The technology could be used to enable and/or augment the capabilities of imaging, especially medical imaging, based upon non scattered photons. This is because we can modulate polarization at very high speeds/high rates, and so create timing information on photons which would enable planar imaging—as with magnetic resonance imaging (MRI). This application, as implemented in suitable equipment such as a medical scanner, could also use low temperature operation/materials for improved performance.

### REFERENCES

[1]. Yablonovitch, E. Photonic band-gap structures. J. Opt. Soc. Am. B 10, 283-295 (1993).
[2]. Joannopoulos, J. D., Villeneuve, P. R. & Fan, S. Photonic crystals: putting a new twist on light. Nature 386, 143-149 (1997).
[3]. Song, B.-S., Noda, S. & Asano, T. Photonic devices based on in-plane hetero photonic crystals. Science 300, 1537-1537 (2003).
[4]. Reithmaier, J. P., Sek, G., Löffler, A., Hofmann, C., Kuhn, S., Reitzenstein, S., Keldysh, L. V, Kulakovskii, V. D., Reinecke, T. L. & Forchel, A. Strong coupling in a single quantum dot-semiconductr microcavity system. Nature 432, 197-200 (2004).
[5]. Yoshie, T., Scherer, A., Hendrickson, J., Khitrova, G., Gibbs, H. M., Rupper, G., Ell, C., Shchekin, O. B. & Deppe, D. G. Vacuum Rabi splitting with a single quantum dot in a photonic crystal nanocavity. Nature 432, 200-203 (2004).
[6]. Gammon, D., Snow, E. S., Shanabrook, B. V., Katzer, D. S. & Park, D. Fine structure splitting in the optical spectra of single GaAs quantum dots. Phys. Rev. Lett. 76, 3005-3008 (1996).
[7]. Bayer, M., Kuther, A., Forhel, A., Gorbunov, A., Timofeev, V. B., Schafer, F., Reithmaier, J. P., Reinecke, T. L. & Walck, S. N. Electron and hole g factors and exchange interaction from studies of the exciton fine structure in In_{0.60}Ga_{0.40}As quantum dots. Phys. Rev. Lett. 82, 1748-1751 (1999).
[8]. Dzhioev, R. I., Zakharchenya, B. P., lvchenko, E. L., Korenev, V. L., Kusraev, Yu. G., Ledentsov, N. N., Ustinov, V. M., Zhukov, A. E. & Tsatsul'nikov, A. F. Optical orientation and alignment of excitons in quantum dots. Phys. of Solid State 40, 790-793 (1998); Fiz. Tverd. Tela 40, 858-861 (1998).
[9]. Akimov, I. A., Hundt, A., Flissikowski, T. & Henneberger, F. Fine structure of the trion triplet state in a single self-assembled semiconductor quantum dot. Appl. Phys. Lett. 81, 470-472 (2002).
[10]. Ivchenko, E. L. & Pikus, G. E. Superlattices and other heterostructures. Symmetry and optical phenomena. Springer-Verlag, Berlin, 1995.
[11]. Dyakonov, M. I. & Perel, V. I. in Optical orientation. Edited by Meyer, M. & Zakharchenya, B. P. North-Holland, Amsterdam, 1984.
[12]. Ivchenko, E. L., Kochereshko, V. P., Naumov, A. Yu., Uraltsev, I. N. & Lavallard, P. Magnetic-field-effects on photoluminescence polarization in type II GaAs/AlAs superlattices. Superlatt. Microstruct. 10, 497-501 (1991).
[13]. Dzhioev, R. I., Gibbs, H. M., lvchenko, E. L., Khitrova, G., Korenev, V. L., Tkachuk, M. N. & Zakharchenya, B. P. Determination of interface preference by observation of linear-to-circular polarization conversion under optical orientation of excitons in type-II GaAs/AlAs superlattices. Phys. Rev. B 56, 13405-13413 (1997).
[14]. Gourdon, C. & Lavallard, P. Fine structue of heavy excitons in GaAs/AlAs superlattices. Phys. Rev. B 46, 4644-4650 (1992).
[15]. Flissikowski, T., Akimov, I. A., Hundt, A. & Henneberger, F. Single-hole spin relaxation in a quantum dot. Phys. Rev. B 68, 161309-1-161309-4 (2003).
[16]. Kroutvar, M., Ducommun, Y., Heiss, D., Bichler, M., Schuh, D., Abstreiter, G. & Finley, J. J. Optically programmable electron spin memory using semiconductor quantum dots. Nature 432, 81-84 (2004).
[17]. Flissikowski, T., Hundt, A., Lowisch, M., Rabe, M. & Henneberger, F. Photon beats from a single semiconductor quantum dot. Phys. Rev. Lett. 86, 3172-3175 (2001).
[18]. Datta, S. & Das, B. Electronic analog of the electro-optic modulator. Appl. Phys. Lett. 56, 665-667 (1990).
[19]. Rabe, M., Lowisch, M. & Henneberger, F. Self-assembled CdSe quantum dots formation by thermally activated surface reorganization. J. Crys. Growth 184/185, 248-253 (1998).

1. A method for polarization conversion from linear polarization to circular polarization, and vice versa, based on anisotropic exchange splitting in low-symmetry quantum dots

2. The method according to claim 1 where the low-symmetry in the quantum dots is achieved and/or partially achieved using shape anisotropy of the quantum dots.

3. The method according to claim 1 where the low-symmetry in the quantum dots is achieved and/or partially achieved using methods other than shape anisotropy, such as but not limited to composition variation, crystallographic anisotropy and/or structural variation, and for by the use of externally applied influences such as but not limited to magnetic and/or electrical fields.

4. The method according to claim 1 involving zero applied magnetic field.

5. The method according to claim 1 involving an applied voltage bias.

6. The method according to claim 1 where this bias and/or other means is used to control and/or select the polarization state of a photon, and thus the spin stale of the photon-induced electron.

7. The method according to claim 1 where this bias and/or other means is used to control and/or select the spin state of an electron, and thus the polarization state of the electron-induced photon.

8. The method according to claim 1 where polarization modulation is enabled by means such as but not limited to the polarization conversion being carried out repeatedly and at very high speeds and/or high rates.

9. The method according to claim 1 where the polarization modulation is carried out at very high speeds and/or high rates and timing information on non scattered photons is created.

10. The method according to claim 2 where the polarization modulation is carried out at very high speeds and/or high rates and timing information on non scattered photons is created, and this information is used to enable planar imaging.

11. Device and/or component such as but not limited to photonic crystals, optical circuits, and spintronics elements, containing quantum dots according to claim 1, used for applications such as but not limited to optical polarization conversion, optical polarization selection, electro-optical modulation, and spintronics spin-selection, spin-conversion, and control.

12. Device and/or component according to claim 11 used in applications such as but not limited to optical computing networks for e.g., optical information processing, quantum computation, holography, and optical recording, and such as but not limited to spintronics systems for e.g., information storage and information processing.

13. Device and/or component according to claim 11 where the quantum dots are self-assembled, such as but not limited to CdSe/ZnSe systems.

14. Device and/or component according to claim 11 in applications in displays, such as but not limited to applications where the technology operates in a similar manner to a conventional liquid crystal display module.

15. Device and/or component according to claim 11 in applications in optical elements, such as but not limited to applications where the technology operates in a similar manner to a conventional liquid crystal module, such as but not limited to scanner elements, shutters, sensors and switches.

16. Device and/or component according to claim 11 in applications in optical switching, such as but not limited to switches, attenuators, isolators and modulators.

17. Device and/or component according to claim 11 in applications in ultra high speed Boolean based logic.

18. Device and/or component according to claim 1 in applications in imaging such as but not limited to medical imaging and/or in instruments such as but not limited to scanners.

19. Device and/or component according to claim 11 based on the modulation of polarization at very high speeds and/or high rates.

20. Device and/or component according to claim 11 based upon the modulation of polarization at very high speeds and/or high rates, so creating timing information on photons, which may be used in applications such as but not limited to planar imaging based upon nun-scattered photons and/or in instruments such as but not limited to scanners.

21. Device and/or component containing quantum dots according to claim 2, which switches between two polarization states of the transmitted light or electromagnetic radiation as a result of an applied electric and/or magnetic field.

22. Device and/or component according to claim 21 where the conversion from linear to circular polarization can be controlled by the application of an electric field perpendicular the plane of the quantum dots.

23. Device and/or component according to claim 21 where the degree and/or sign of the ellipticity of the polarization of the outgoing beam can be controlled by the application of an electric field in the plane of the quantum dots.

24. Device and/or component according to claim 21 where the degree and/or sign of the ellipticity of the polarization of the outgoing beam can be controlled by the application of a magnetic field in the plane or perpendicular to the plane of the quantum dots.

25. Device and/or component according to claim 21 where the outgoing polarization can be modulated by the application of oscillating (AC) electric or magnetic fields or by subjecting the dots to an electromagnetic wave.

26. Device and/or component according to claim 11 where a single quantum dot is used instead of a quantum dot ensemble.

27. Device and/or component according to claim 11 where the assembly is achieved through lithographic processes.

28. Device and/or component according to claim 11 where functional element is coupled to input and/or output fiber optics.

29. Device and/or component according to claim 28 where the coupling to the fiber optic is achieved through waveguide.

30. Device and/or component according to claim 28 where the coupling to the fiber optic is achieved through tapered fibers.
